(19) United States
(12) Patent Application Publication
(10) Pub. No.: US 2014/0168694 A1
(43) Pub. Date: Jun. 19, 2014

(54) IMAGE PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: Junichi Hiruma, Hidaka-shi (JP)

(73) Assignee: CANON KABUSHIKI KAISHA, Tokyo (JP)

(21) Appl. No.: 14/085,178

(22) Filed: Nov. 20, 2013

(30) Foreign Application Priority Data
Dec. 17, 2012 (JP) 2012-275103

(51) Int. Cl. G06F 3/12

(52) U.S. Cl. CPC G06F 3/1253
USPC 358/1.15

(57) ABSTRACT

An image processing apparatus according to an aspect of the present invention is configured to detect an execution status of a transmission job, upon receipt of a display instruction to display information on the transmission job after execution of the transmission job has started, and to perform display control in accordance with the detected execution status of the transmission job. Specifically, the image processing apparatus is configured to display a job history screen on the display unit when it is detected that the execution of the transmission job has already been terminated, and to display a job status screen on the display unit when it is detected that the execution of the transmission job has not been terminated.

### BACKGROUND OF THE INVENTION

1. Field of the Invention

The present invention relates to an image processing apparatus that enables a user to confirm an execution status of a transmission job, a method for controlling the same, and a storage medium.

2. Description of the Related Art

Conventionally, an image processing apparatus such as a multi-function peripheral (MFP) provides a transmission service for transmitting a file such as an image file via FAX, e-mail, or the like. Such an image processing apparatus displays a screen that enables a user to confirm an execution status (for example, job execution success/failure) of a job (transmission job) for providing the transmission service. This is because, with respect to the transmission job, the user cannot confirm an execution result of the job unless information on the execution result is displayed on the screen, unlike a job such as a copy job or a print job whose job execution result a user can confirm with the sheets that were output.

Generally, an image processing apparatus such as an MFP has a function of displaying either a job status screen that shows an execution status of a job or a job history screen that shows an execution history of the job, depending on information on the job that a user needs. In such an image processing apparatus, for example, when the user wants to confirm the state of a job that is currently being executed or is waiting for being executed (during standby), the user should browse the job status screen that shows the execution status of the job (see, for example, Japanese Patent Laid-Open No. 2012-39179 and Japanese Patent Laid-Open No. 2000-75981). On the other hand, when the user wants to confirm the execution result of a job whose execution is terminated, the user should browse the job history screen.

The above-described conventional technology has the following problem. Specifically, when a user instructs an image processing apparatus to perform a transmission job and then confirms an execution status of the transmission job, it is sometimes difficult for the user to appropriately determine which one of the above-described job status screen and job history screen to browse.

For example, if, after the user operates a transmission screen for instructing to start executing a transmission job, information on the execution status of the job is not displayed, the user cannot determine which timing the execution of the transmission job is terminated (that is, which timing the transmission is completed). Even if the user browses the job status screen at a timing at which the execution of the transmission job is terminated, the information on the job whose execution is terminated cannot be confirmed on that screen. Also, even if the user browses the job history screen at a timing at which the transmission job is still being executed, the information on the job whose execution has not been terminated cannot be confirmed on that screen.

Therefore, when neither the job status screen nor the job history screen that is being displayed includes information on a transmission job that the user tries to confirm, the user cannot immediately confirm based on the displayed screen whether or not the transmission job was correctly instructed and executed. Accordingly, the user may need an additional operation for enabling information on the transmission job to be browsed, which results in deterioration in the user's convenience.

### SUMMARY OF THE INVENTION

The present invention is made in view of the above-described problem. The present invention is to provide a technology for enabling a user, when a transmission job has started to be executed in an image processing apparatus, to confirm information on the transmission job without deteriorating the user's convenience.

According to one aspect of the present invention, there is provided an image processing apparatus capable of communicating with an external apparatus via a network, the image processing apparatus comprising: a reception unit configured to receive, after execution of a transmission job for transmitting image data to the external apparatus has started, a display instruction to display information on the transmission job; a detection unit configured to detect an execution status of the transmission job upon receipt of the display instruction by the reception unit; and a display control unit configured to display, on a display unit of the image processing apparatus, a job status screen that shows an execution status of a job that is currently being executed in the image processing apparatus, or a job history screen that shows an execution history of a job whose execution in the image processing apparatus is terminated, in accordance with the execution status detected by the detection unit.

According to another aspect of the present invention, there is provided a method for controlling an image processing apparatus capable of communicating with an external apparatus via a network, the method comprising steps of: receiving, after execution of a transmission job for transmitting image data to the external apparatus has started, a display instruction to display information on the transmission job; detecting an execution status of the transmission job upon receipt of the display instruction in the receiving step; and displaying, on a display unit of the image processing apparatus, a job status screen that shows an execution status of a job that is currently being executed in the image processing apparatus, or a job history screen that shows an execution history of a job whose execution in the image processing apparatus is terminated, in accordance with the execution status detected in the detecting step.

According to still another aspect of the present invention, there is provided a computer-readable storage medium storing a computer program for causing a computer to execute steps of a method for controlling an image processing apparatus capable of communicating with an external apparatus via a network, the method comprising steps of: receiving, after execution of a transmission job for transmitting image data to the external apparatus has started, a display instruction to display information on the transmission job; detecting an execution status of the transmission job upon receipt of the display instruction in the receiving step; and displaying, on a display unit of the image processing apparatus, a job status screen that shows an execution status of a job that is currently being executed in the image processing apparatus, or a job history screen that shows an execution history of a job whose execution in the image processing apparatus is terminated, in accordance with the execution status detected in the detecting step.

According to the present invention, it is possible to provide a technology for enabling the user, when a transmission job has started to be executed in an image processing apparatus, to confirm information on the transmission job without deteriorating the user's convenience.

Further features of the present invention will become apparent from the following description of exemplary embodiments (with reference to the attached drawings).

### BRIEF DESCRIPTION OF THE DRAWINGS

FIG. 1 is a diagram illustrating an example of a network configuration according to an embodiment of the present invention.

FIG. 2 is a block diagram illustrating an example of a hardware configuration of an MFP according to an embodiment of the present invention.

FIG. 3 is a block diagram illustrating an example of a software configuration relating to execution of a transmission job, of the MFP according to an embodiment of the present invention.

FIG. 4A is a diagram illustrating examples of a job history screen and a job status screen that are displayed on the MFP according to an embodiment of the present invention.

FIG. 4B is a diagram illustrating examples of the job history screen and the job status screen that are displayed on the MFP according to an embodiment of the present invention.

FIG. 5 is a diagram illustrating an example of a job management table that includes information on jobs that are executed by the MFP according to an embodiment of the present invention.

FIG. 6 is a diagram illustrating an example of an operation screen that is used for configuring settings for execution of a transmission job according to an embodiment of the present invention.

FIG. 7 is a diagram illustrating an example of an address book screen that shows addresses that a user can designate and causes the user to designate a transmission destination in the MFP according to an embodiment of the present invention.

FIG. 8 is a diagram illustrating an example of a FAX execution screen that is used for instructing to execute a FAX job for transmitting image data to an address designated via the address book screen illustrated in FIG. 7.

FIG. 9 is a diagram illustrating an example of a guidance popup screen that is displayed on an operation unit after a FAX job or a transmission job was generated, according to an embodiment of the present invention.

FIG. 10 is a diagram illustrating an example of an operation screen for causing a user to set whether or not to display the guidance popup screen (FIG. 9), after the transmission job has started to be executed, according to an embodiment of the present invention.

FIG. 11 is a diagram illustrating an example of an operation screen for setting a screen to be displayed when the execution status of the transmission job shows “during transmission” or “during standby”, according to an embodiment of the present invention.

FIG. 12 is a flowchart illustrating procedures of display control of information on a transmission job that is executed by the MFP when execution of the transmission job has instructed, according to a first embodiment.

FIGS. 13A and 13B are flowcharts illustrating procedures of display control of information on a transmission job that is executed by the MFP when execution of the transmission job has instructed, according to a second embodiment.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

<Network Configuration>

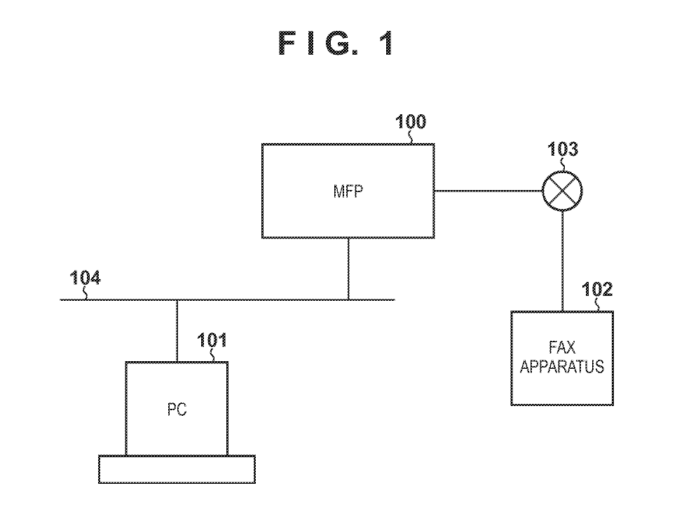

FIG. 1 is a block diagram illustrating an example of a network configuration according to embodiments of the present invention. A multi-function peripheral (MFP) 100 is an example of an image processing apparatus that is capable of communicating with an external apparatus via a network, and is installed in an office or the like. In FIG. 1, the MFP 100 is connected to a PC via a LAN 104 and is connected to a FAX apparatus 102 via a telephone line 103, that is, the MFP 100 is capable of communicating with an external apparatus via the LAN 104 or the telephone line 103. The MFP 100 has a scanner function, a printer function, and the like and provides a copy service, a transmission service such as e-mail transmission, a FAX transmission service and a FAX reception service of facsimile communication (FAX communication) a network print service, and the like.

Hereinafter, a function of the MFP 100 to transmit a file (image data) to an external apparatus by a transmission method (protocol) other than facsimile communication (FAX communication) is referred to as “SEND function”, and a function of the MFP 100 to transmit a file to an external apparatus by FAX communication is referred to as “FAX function”. In addition, jobs that use the SEND function and the FAX function are respectively referred to as a “SEND job” and a “FAX job”. Note that the “SEND job” and “FAX job” are sometimes collectively referred to as a “transmission job”.

<Configuration of the Image Processing Apparatus (MFP)>

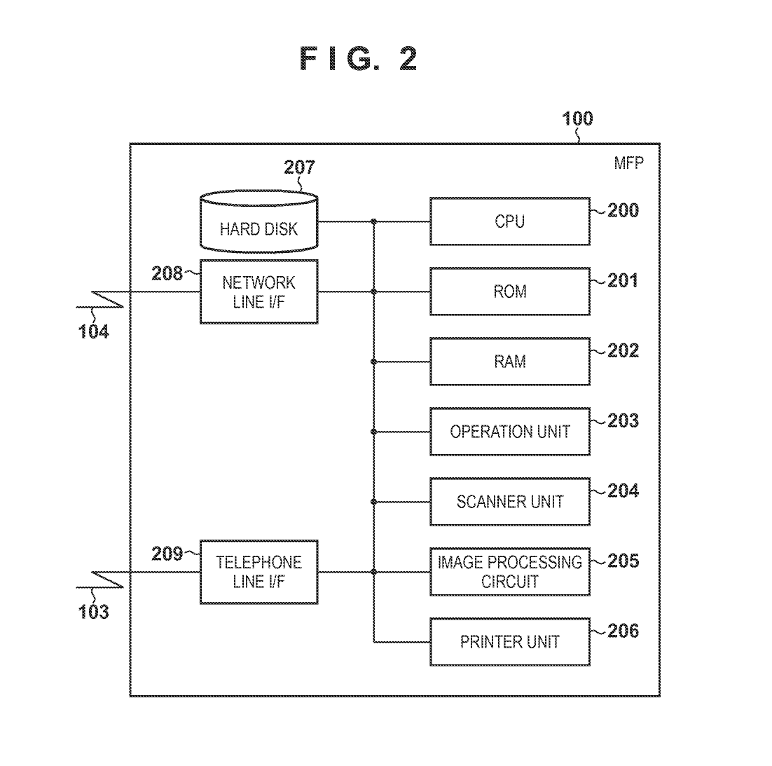

FIG. 2 is a block diagram illustrating an example of a configuration of the MFP 100 according to the embodiments of the present invention. A CPU 200 controls overall operation of the MFP 100 by reading out a program stored in a ROM 201 onto a RAM 202 and executing the program. The RAM 202 is a volatile storage medium that is used as a work area for the CPU 200 or a temporal storage area in which various types of data are stored. An operation unit 203 is provided with a liquid crystal display unit (LCD), and hard keys such as a start key and a numerical keypad, and receives a user's operation. A scanner unit 204 reads an image of an original, and generates image data by photoelectric conversion. An image processing circuit 205 includes a high-capacity image memory, an image rotation circuit, a resolution conversion circuit, a coding/decoding circuit that supports MH, MR, MMR, JBIG, JPEG, and the like, and other component, and can execute various types of image processing such as shading, trimming, masking, and the like. A printer unit 206 prints an image based on the image data on a sheet.

A hard disk 207 is a high-capacity nonvolatile storage medium that is connected via an interface (I/F) such as SCSI or IDE. A network line I/F 208 is an interface circuit for connecting the MFP 100 to the network line (LAN 104). A telephone line I/F 209 is an interface circuit for connecting the MFP 100 to the telephone line. Actually, the scanner unit 204, the image processing circuit 205, and the printer unit 206 are connected to each other via a high speed video bus other than a CPU bus connected to the CPU 200, and can transfer image data to each other at a high speed. In the MFP 100, the image processing circuit 205 performs various types of image processing for the image data obtained by the scanner unit 204 reading an original, or the image data that is used for printing by the printer unit 206.

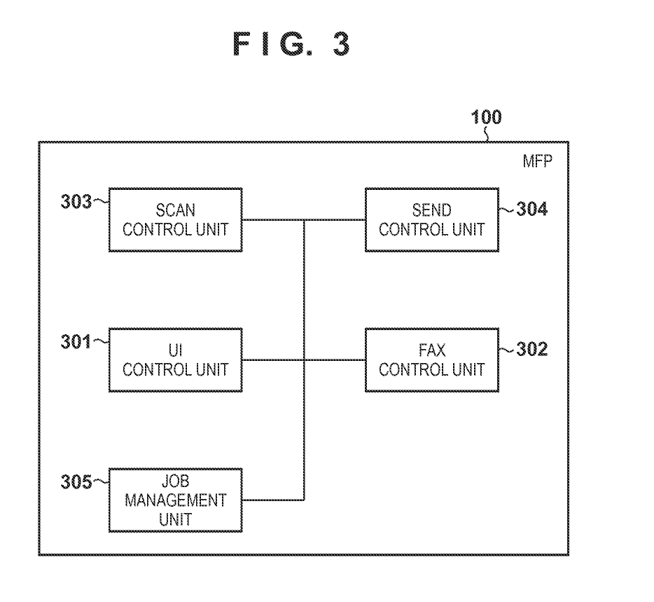

FIG. 3 is a diagram illustrating an example of a software configuration relating to execution of a transmission job, of the MFP 100 according to the present embodiment. Functions in the blocks shown in FIG. 3 are realized on the MFP 100 by the CPU 200 reading out a control program stored in the ROM 201 onto the RAM 202 and executing the control program.

The MFP 100 includes, as a software configuration, a user interface (UI) control unit 301, a FAX control unit 302, a scan control unit 303, a SEND control unit 304, and a job management unit 305. The UI control unit 301 controls operation of the operation unit 203. The FAX control unit 302 controls FAX sending and reception via the telephone line I/F 209. The scan control unit 303 controls processing for reading image data performed by the scanner unit 204. The SEND control unit 304 controls transmission of files (image data) via the network line I/F 208.

The job management unit 305 manages information on a transmission job for performing transmission using the SEND function or the FAX function. The job management unit 305 manages, for example, states (execution statuses) of a FAX job and a SEND job with information such as “during standby”, “during transmission”, and “terminated”. Also, the job management unit 305 manages, with respect to each transmission job, transmission destination (address) of the job, the start time/termination time of the job, and detailed information indicating what the job is.

<Examples of the Job History Screen and the Job Status Screen>

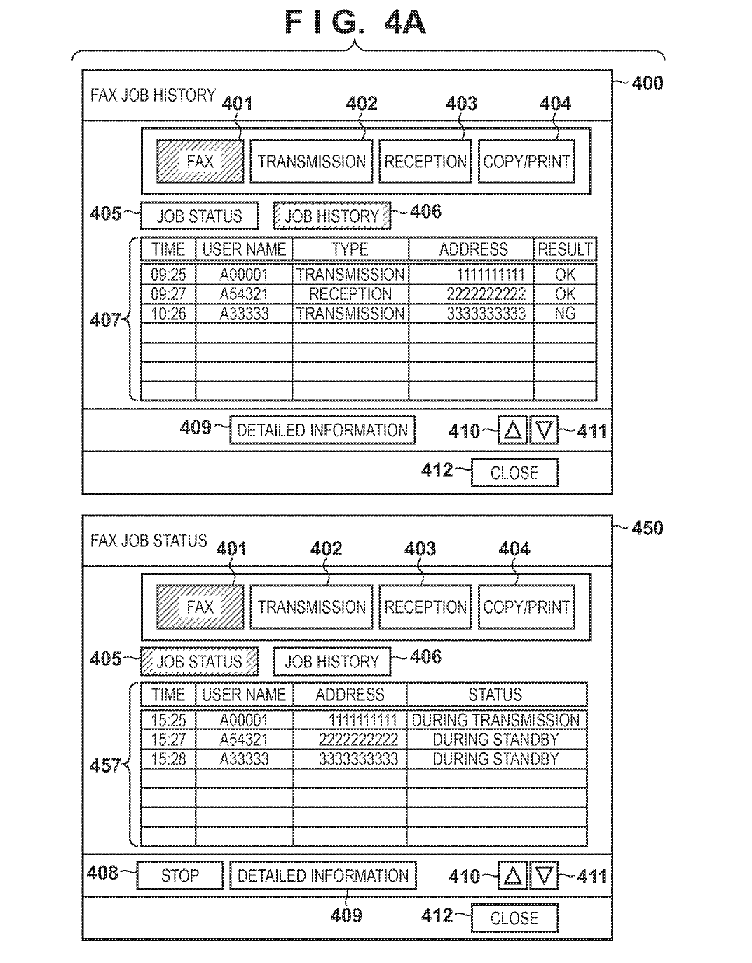

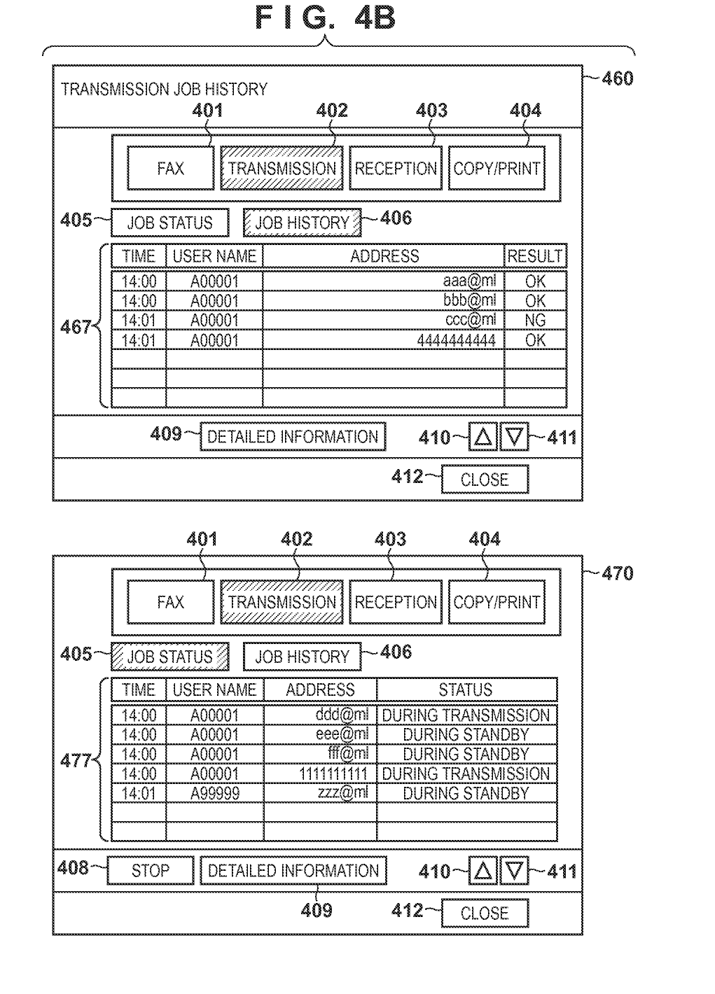

The following will describe examples of the job history screen and the job status screen (screens 400, 450, 460, and 470) that are displayed by the UI control unit 301 on the operation unit 203 of the MFP 100 according to an embodiment of the present invention, with reference to FIGS. 4A and 4B. The screens 400, 450, 460, and 470 include common UI components that are classified roughly into the following five categories:

(1) Buttons for selecting the type of jobs to be displayed: a FAX job display button 401, a transmission job display button 402, a reception job display button 403, a copy/print job display button 404 (job category buttons 401 to 404);

(2) Buttons for displaying job information: a job status display button 405 and a job history display button 406;

(3) A button for displaying job information further in detail: a detailed information display button 409;

(4) Buttons for displaying other job information: a scroll-up button 410 and a scroll-down button 411; and

(5) A button for closing the displayed screen: a close button 412.

The upper diagram of FIG. 4A shows an example of the job history screen (screen 400) relating to FAX jobs. The job history screen 400 is a screen that shows a list of execution results of FAX jobs whose execution has already been terminated, and includes items indicating information unique to the FAX jobs. The job history screen 400 is displayed on the operation unit 203 when a user operates the FAX job display button 401 for instructing to display job information on the FAX jobs, and the button 406 for instructing to display execution histories of the jobs. Note that the buttons operated by the user, such as the buttons 401 and 406 shown in the job history screen 400, are displayed in a highlighted manner.

The display screen (job history screen 400) of the operation unit 203 changes, depending on a user's operation, as follows.
When the transmission job display button 402 is pressed, information on one or more transmission jobs including a FAX job is displayed.
When the reception job display button 403 is pressed, information on one or more reception jobs is displayed.
When the copy/print job display button 404 is pressed, information on one or more copy/print jobs is displayed.

—When the job status display button 405 is pressed, information on one or more jobs that are being currently executed or that are during standby, from among jobs designated by the job category buttons 401 to 404, is displayed.
When the job history display button 406 is pressed, information on one or more jobs whose execution is terminated, from among the jobs designated by the job category buttons 401 to 404, is displayed.

Note that, for ease of illustration, description on display contents is omitted that relate to the reception job and the copy/print job, which are performed when the buttons 403 and 404 are pressed and have less relevance to the present embodiment.

In the job history screen 400, a list display region 407 shows, as information on FAX jobs whose execution is terminated, information such as the time at which the jobs were executed, the names of users who instructed the execution, the types of the jobs, the transmission or reception addresses, and the execution results. When the user wants more detailed information on the jobs shown in the list display region 407 to be displayed, the user may select any one job and then press the detailed information display button 409. Also, the scroll-up button 410 and the scroll-down button 411 are used for displaying, while scrolling, information on a job that was executed prior to or subsequent to the jobs that are currently displayed on the list display region 407. The close button 412 is used for closing the screen that is currently being displayed.

The lower diagram of FIG. 4A shows an example of the job status screen (screen 450) relating to FAX jobs. The job status screen 450 is a screen that shows only information on job execution statuses of FAX jobs whose execution is not terminated (“during transmission” or “during standby”), and includes items indicating information unique to the FAX jobs. A list display region 457 shows, as information on FAX jobs whose execution is not terminated, information such as the time at which the jobs were executed, the names of users who instructed the execution, the transmission destinations (addresses), and the execution statuses.

The upper diagram of FIG. 4B shows an example of the job history screen (screen 460) relating to transmission jobs (including a FAX job and a SEND job). The job history screen 460 is a screen that shows, in a list, results of transmission jobs whose execution is terminated. On the job history screen 460, the user can confirm execution histories of all the transmission jobs (the SEND and FAX jobs). The list display region 467 includes items indicating information common to all the transmission jobs, in order to enable information on all the transmission jobs to be shown. For example, unlike the list display region 407 that corresponds to FAX jobs, the list display region 467 does not include an item that indicates job types.

The lower diagram of FIG. 4B shows an example of the job status screen (screen 470) relating to transmission jobs (including a FAX job and a SEND job). The job status screen 470 is a screen that shows information on job execution statuses of transmission jobs whose execution is not terminated (“during standby” or “during transmission”). On the job status screen 470, the user can confirm execution statuses of all the transmission jobs (the SEND job and the FAX job). The list display region 477 includes items indicating information common to all the transmission jobs, in order to enable information on all the transmission jobs to be shown.

<An Example of a Job Management Table>

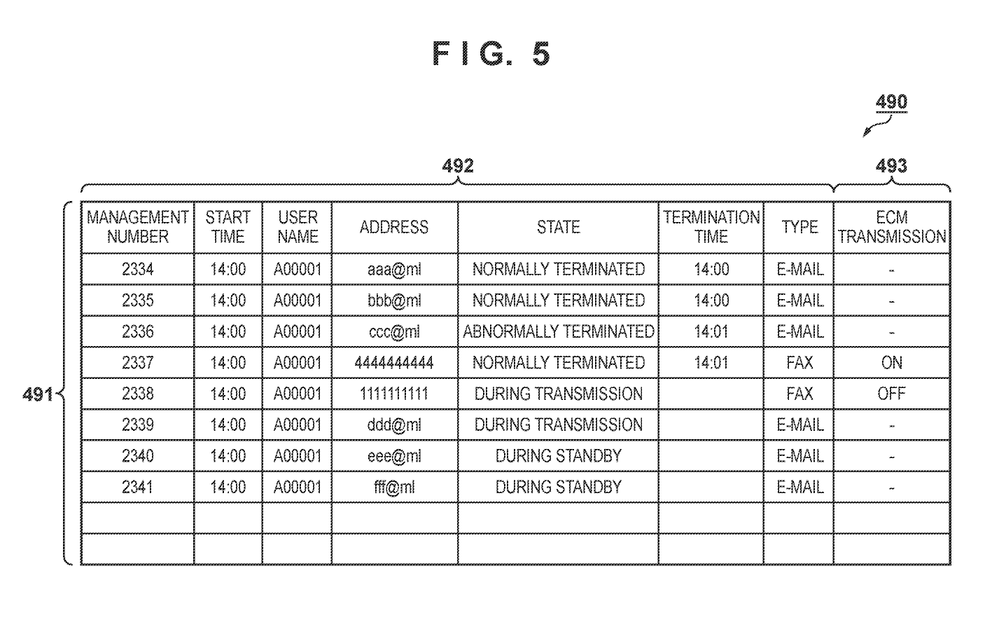

FIG. 5 is a diagram illustrating an example of a job management table that includes information on jobs that are executed by the MFP 100, the job management table being generated by the job management unit 305.

FIG. 5 shows, as an example, a job management table 490 that is generated by the job management unit 305 when the user “A00001” uses transmission jobs. Note that the display contents included in the job history screen 460 and the job status screen 470 shown in FIG. 4B correspond to the information included in the job management table 490.

The job management table 490 includes information on eight jobs whose execution is instructed by the user “A00001”, as shown in a job list 491. Items 492 are items common to all the transmission jobs, such as the types of the jobs, the states of the jobs (execution statuses), the start time, the termination time, and the like. On the other hand, an item 493 is an item relating to ECM transmission information, that is, an item unique to the FAX function.

<Examples of Other Operation Screens of the MFP>

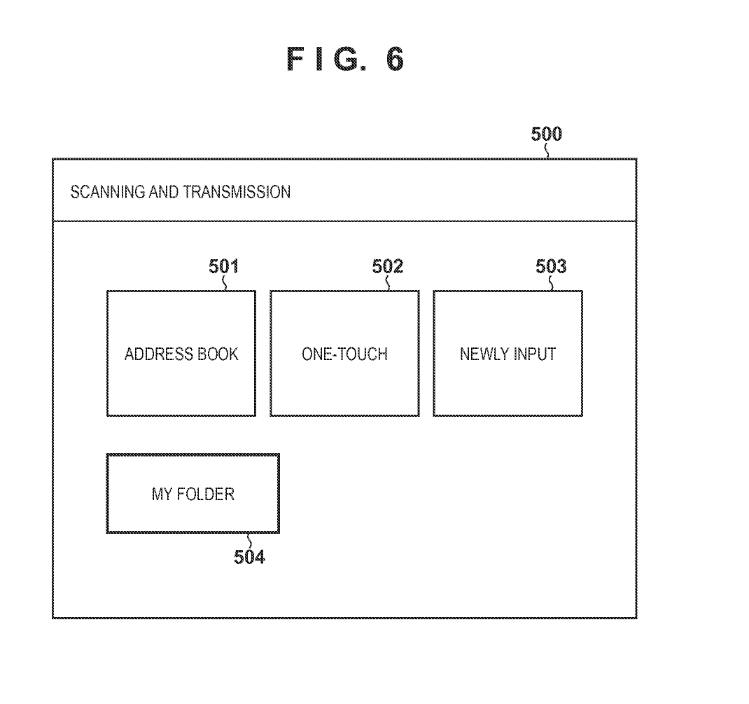

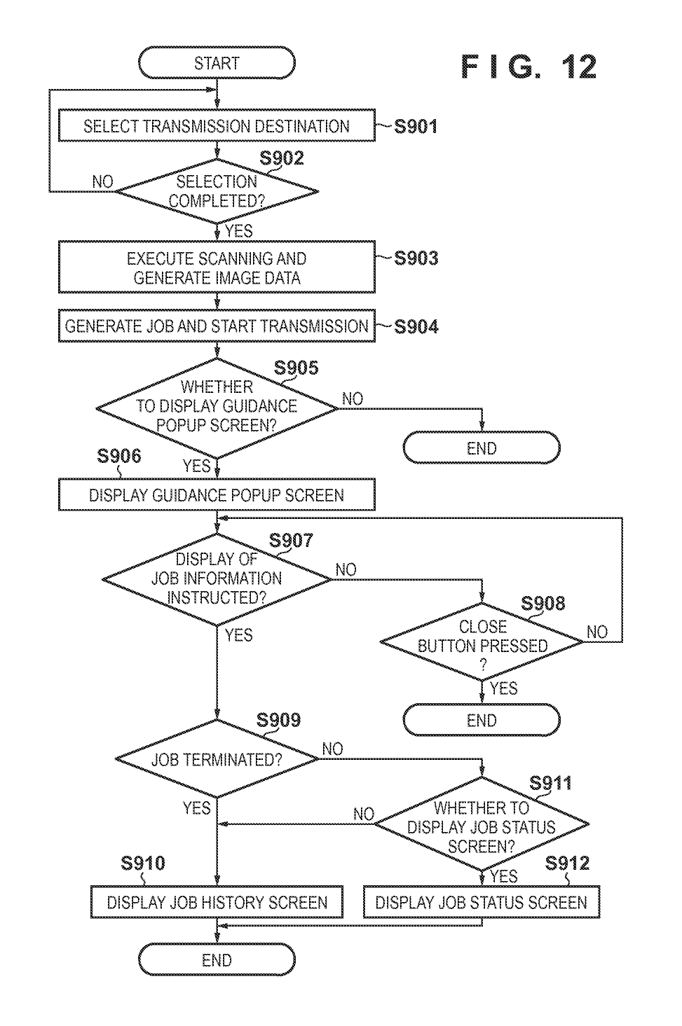

FIG. 6 is a diagram illustrating an example of an operation screen (500) that is used for configuring settings for execution of a transmission job by the MFP 100, and shows an example of a screen that is displayed on the operation unit 203 in step S901 of FIG. 12, which will be described later.

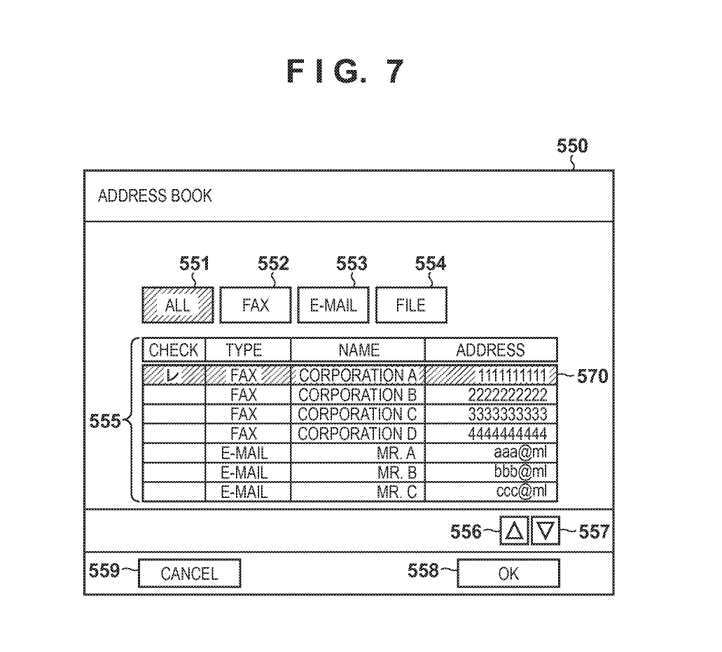

In the operation screen 500, an address book button 501 is used for shifting the display of the operation unit 203 to an address book screen 550 (FIG. 7) for prompting the user to designate a transmission destination (address). A one-touch button 502 is used for shifting the display to a screen (not shown) for enabling, by a simple button operation, image data to be transmitted to a transmission destination registered in advance. A newly input button 503 is used for shifting the display of the operation unit 203 to a screen (not shown) relating to a function by which the user manually designates an address of the transmission destination. A my folder button 504 is used for shifting the display of the operation unit 203 to a screen (not shown) relating to a function for transmitting image data to a folder unique to a user who has logged in the MFP 100.

FIG. 7 is a diagram illustrating an example of the address book screen (550) that displays transmission destinations (addresses) that a user can designate in the MFP 100, and prompts the user to designate a transmission destination from among them.

A button 551 is used for displaying all preregistered transmission destinations (addresses) that can be designated for transmission jobs (including a FAX job and a SEND job). When the button 551 is pressed, information on all the registered addresses is displayed on an address display region 555. When a button 552 is pressed, information on a registered address unique to a FAX job is displayed on the address display region 555. When a button 553 is pressed, information on a registered address (e-mail address) unique to a SEND job is displayed on the address display region 555. When a button 554 is pressed, information on a registered address (file storage destination) unique to a SEND job is displayed on the address display region 555.

The address display region 555 displays the information on the addresses that can be designated for transmission jobs (including a FAX job and a SEND job), and is used for prompting the user to select an address from among them. In FIG. 7, the address display region 555 shows that address information 570 corresponding to an address of “A corporation” as the name is being selected (in a highlighted display state). FIG. 7 shows that, with respect to “A corporation”, the type of the job is “FAX” and an address thereof is “1111111111”, and a check mark is added in a check column (CHECK), indicating that this address is selected by the user.

A scroll-up button 556 and a scroll-down button 557 are used for performing scrolling display so as to enable address information other than address information that is currently displayed on the address display region 555 to be selected. An OK button 558 is used, after the selected address is set as an address to be used for the transmission job, for terminating the display of the address book screen 550 that is currently being displayed and shifting the display of the operation unit 203 to a transmission execution screen 600. A cancel button 559 is used for cancelling the selected address, terminating the display of the address book screen 550 that is currently being displayed, and shifting the display of the operation unit 203 to the operation screen 500.

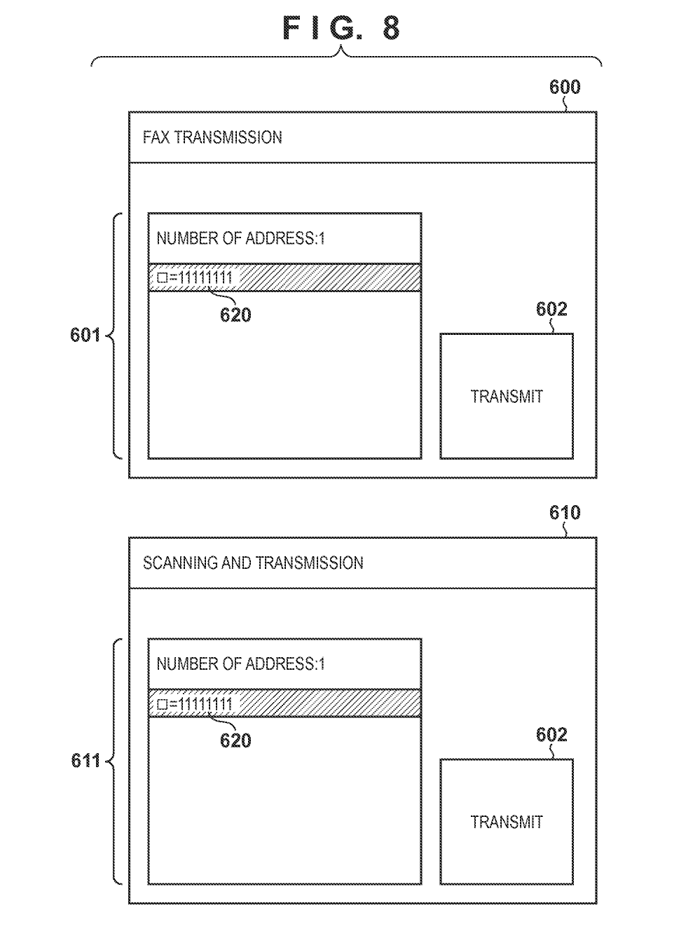

FIG. 8 is a diagram illustrating an example of transmission execution screens (600 and 610) that are used for instructing to execute a FAX job for transmitting image data to an address designated via the address book screen 550 illustrated in FIG. 7. Note that the transmission execution screen 600 is used for instructing transmission of image data only by a FAX job, and the transmission execution screen 610 is used for instructing transmission of image data by a transmission job including a FAX job and a SEND job.

In the transmission execution screen 600 that corresponds to a FAX job, an address display region 601 displays an address to which image data is transmitted by using the FAX function. Address information 620 displayed in the address display region 601 shows that the address (telephone number of “1111111111”) that corresponds to the address information 570 selected in the address book screen 550 is determined as a transmission destination of the FAX job. A button 602 is used for instructing the scanner unit 204 to start reading (scanning) an image of an original, and instructing the MFP to transmit the generated image data to the address displayed in the address display region 601. When the button 602 is pressed, the CPU 200 generates the FAX job for transmitting, using the FAX function, the image data to the transmission destination indicated by the telephone number “1111111111”, and executes the generated FAX job.

Also, in the transmission execution screen 610 that corresponds to a transmission job, an address display region 611 displays an address to which the image data is transmitted by a predetermined transmission method (protocol) including facsimile. However, in FIG. 8, the address display region 611 displays, as address information 620, the address for the FAX function. Note that, in the transmission job, image data can be transmitted to a designated address (external apparatus) by a predetermined transmission method using not only the FAX function but also the SEND function.

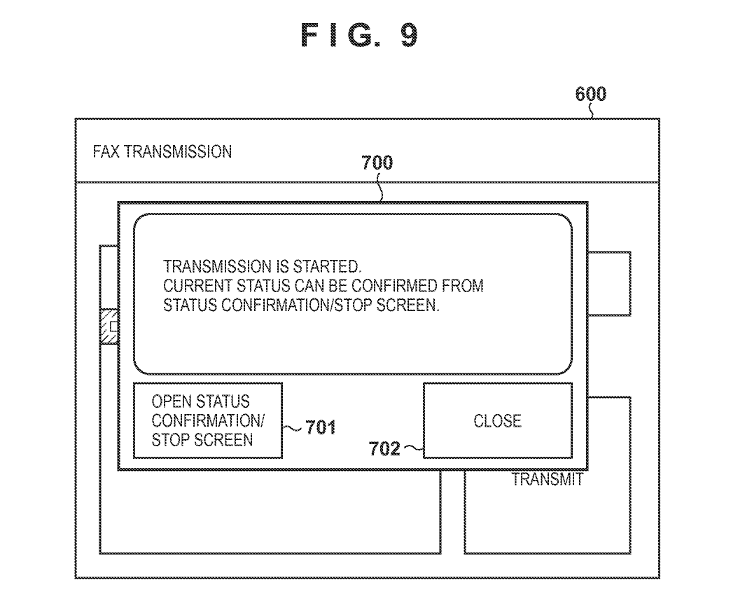

In FIG. 9 is a diagram illustrating an example of a guidance popup screen (700) that is to be displayed on the operation unit 203, after the button 602 on the transmission execution screen 600 or 610 is pressed and the MFP 100 generates a FAX job or a transmission job. The guidance popup screen 700 is displayed on the operation unit 203 in step S905 of FIG. 12.

When a status confirmation button 701 is pressed while the guidance popup screen 700 is being displayed, the CPU 200 shifts the display screen of the operation unit 203 depending on the execution status of the transmission job, in accordance with a flowchart shown in FIG. 12. Specifically, the CPU 200 shifts the screen display of the operation unit 203 to one of the job history screen 400, the job status screen 450, the job history screen 460, and the job status screen 470. Note that a close button 702 is used for closing the display of the guidance popup screen 700 without performing such shifting of the screen display.

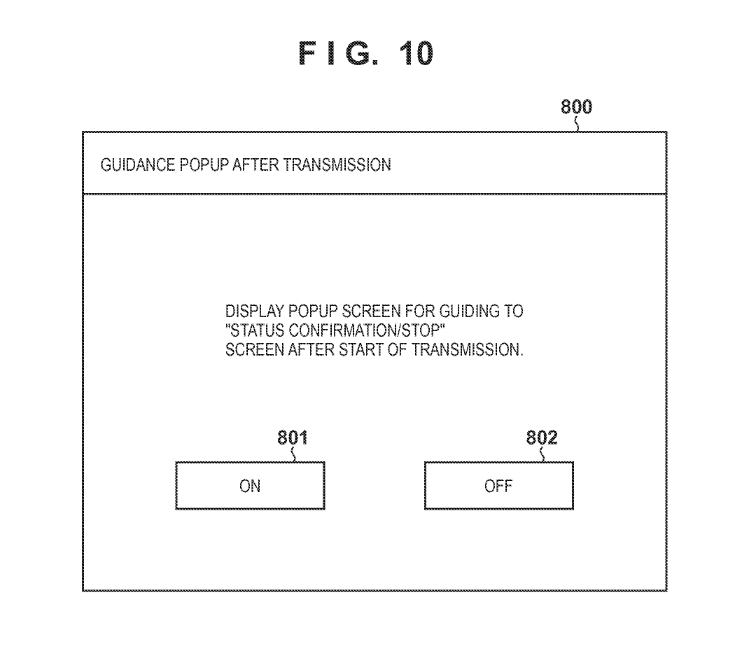

FIG. 10 is a diagram illustrating an example of an operation screen (800) for prompting the user to set whether or not to display the guidance popup screen 700 (FIG. 9) after the start of the execution of the transmission job. When a button 801 is pressed, the CPU 200 sets to display the guidance popup screen 700 with respect to the transmission job. On the other hand, when a button 802 is pressed, the CPU 200 sets not to display the guidance popup screen 700 with respect to the transmission job. Note that the content that is set using the operation screen 800 is used in step S905 of FIG. 12.

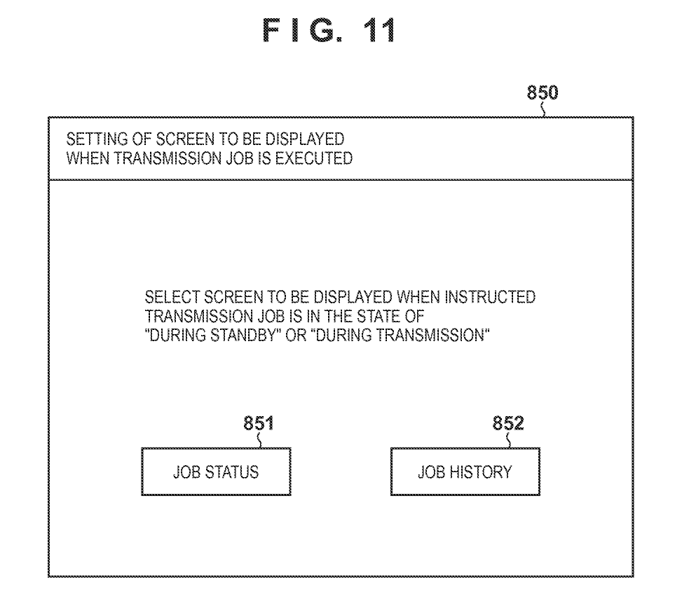

FIG. 11 shows an example of an operation screen (850) for setting a screen that is to be displayed when the execution status of the transmission job is “during transmission” or “during standby”. The operation screen 850 prompts the user to select the job status screen or the job history screen, as the screen that is to be displayed when the execution status of the job is detected to be “during transmission” or “during standby” after the start of the transmission job. When a button 851 on the operation screen 850 is pressed, the CPU 200 sets to display the job status screen, whereas when a button 852 is pressed, the CPU 200 sets to display the job history screen. Note that the content that is set using the operation screen 850 is used in step S911 of FIG. 12.

### First Embodiment

The following will describe display control, according to a first embodiment, of information on a transmission job that is executed by the MFP 100 when the transmission job is instructed to be executed, with reference to FIG. 12. Hereinafter, as the first embodiment, description on processing that is performed when an instruction to execute a FAX job is made using the transmission execution screen 600 for instructing the execution of the FAX job will be made. Note that the procedures of steps shown in FIG. 12 are realized on the MFP 100 by the CPU 200 reading out the control program stored in the ROM 201 onto the RAM 202 and executing the control program. Also, display control of the operation unit 203 is executed by the UI control unit 301.

First, in step S901, when a user presses the address book button 501 while the operation screen 500 for executing a transmission job is being displayed on the operation unit 203, the CPU 200 (UI control unit 301) displays the address book screen 550 on the operation unit 203. With this, the CPU 200 receives, via the operation unit 203, the selection by the user with respect to an address (transmission destination) of the transmission job.

Then, in step S902, the CPU 200 determines whether or not the selection by the user with respect to a transmission destination is completed, and if it is determined that the selection is completed, the procedure advances to step S903, and otherwise the procedure returns to step S901. When the selection with respect to a transmission destination is completed, the CPU 200 displays the transmission execution screen 600 on the operation unit 203.

Next, in step S903, when it is detected that the user has pressed the button 602 on the transmission execution screen 600 that is currently being displayed, the CPU 200 (scan control unit 303) causes the scanner unit 204 to execute scanning of an original, and to generate image data (a file) to be transmitted. Then, in step S904, the CPU 200 (job management unit 305) generates a FAX job for transmitting the generated image data to the transmission destination designated in step S901 by using a FAX function, and registers the FAX job in the job management table 490. Then, the CPU 200 (FAX control unit 302) starts executing the generated FAX job so as to start transmitting the image data.

Specifically, in step S905, the CPU 200 (UI control unit 301) determines, based on the content that was preset using the operation screen 800 (FIG. 10), whether or not to display the guidance popup screen 700 (FIG. 9) on the operation unit 203. If the CPU 200 determines, in step S905, to display the guidance popup screen 700, the procedure advances to step S906, and otherwise the procedure ends.

Next, the CPU 200 determines whether or not information on the transmission job (FAX job) is set to be displayed after the start of the job. In the present embodiment, as an example, the CPU 200 causes the operation unit 203 to display a selection screen for receiving a selection as to whether or not the information on the transmission job is to be displayed. In accordance with the selection via the selection screen, the CPU 200 further determines whether or not the information (job information) on the transmission job is set to be displayed.

Specifically, in step S907, the CPU 200 displays the guidance popup screen 700 on the operation unit 203, and determines whether or not an instruction to display the job information on the FAX job is made via that screen. If the status confirmation button 701 on the guidance popup screen 700 is pressed by the user, the CPU 200 determines that the instruction to display the job information is made and the procedure advances to step S909, and otherwise the procedure advances to step S908. In step S908, the CPU 200 determines whether or not the close button 702 is pressed, and if it is determined that the button is pressed, the procedure ends, and otherwise the procedure returns to step S907.

If, in this manner, the information on the transmission job (FAX job) is set to be displayed after the start of the execution of that job, the CPU 200 detects the execution status of that job, and performs display control of the job status screen or the job history screen in accordance with the detected execution status.

Specifically, in step S909, the CPU 200 (job management unit 305) detects the execution status of the FAX job whose execution has started in step S904, on the basis of the job management table 490. Here, the CPU 200 detects, as the execution status, whether the execution of the FAX job has already been terminated, whether the FAX job is currently being executed, or whether the FAX job is in the standby state before the execution. If the FAX job is currently being executed and if the FAX job is in the standby state before the execution, it means that the execution of the FAX job is not terminated.

If the CPU 200 detects in step S909, as the execution status, that the execution of the FAX job has already been terminated (“Yes” in step S909), the procedure advances to step S910. In 5910, the CPU 200 (UI control unit 301) displays the job history screen 400 that includes information on the FAX job on the operation unit 203 and ends the procedure.

On the other hand, if the CPU 200 detects in step S909, as the execution status, that the execution of the FAX job has not been terminated (“No” in step S909), the procedure advances to step S911. In this case, the CPU 200 (UI control unit 301) may display the job status screen 450 including the information on the FAX job, instead of the job history screen 400, on the operation unit 203. Note that, in the present embodiment, the CPU 200 determines which one of the job history screen 400 and the job status screen 450 is displayed in accordance with the selection instruction by the user. Accordingly, it is possible to realize the display control that meets the user's needs.

In step S911, the CPU 200 determines with respect to the selection instruction by the user, on the basis of the content that was preset using the operation screen 850 (FIG. 11). If the CPU 200 determines in step S911 that the job status screen is set to be displayed, the procedure advances to step S912, where the CPU 200 displays the job status screen 450 including the information on the FAX job on the operation unit 203 and ends the procedure. On the other hand, if the CPU 200 determines that the job history screen is set to be displayed, the procedure advances to step S910, where the CPU 200 displays the job history screen 400 including the information on the FAX job on the operation unit 203 and ends the procedure.

As described above, in the present embodiment, if it is determined that information on a transmission job is set to be displayed after the transmission job has started to be executed, the CPU 200 detects the execution status of the transmission job, and performs display control in accordance with the detected execution status of the transmission job. Specifically, the CPU 200 displays the job history screen on the operation unit 203 if it is detected that the execution of the transmission job has already been terminated, whereas the CPU 200 displays the job status screen on the operation unit 203 if it is detected that the execution of the transmission job has not been terminated.

Accordingly, in the case where the user wants information on a transmission job to be displayed, a screen appropriate for displaying the information is automatically selected and displayed. According to the present embodiment, when the transmission job has started to be executed in the image processing apparatus, by appropriately displaying the information on the transmission job, the user can confirm that information without deterioration of the user's convenience. That is to say, it is possible for the user to easily confirm the execution status of the transmission job.

### Second Embodiment

A second embodiment will describe the case where the MFP receives a plurality of transmission destinations and individual transmission methods for transmitting image data to the respective transmission destinations, as settings of a transmission job, and executes the transmission job in accordance with the received settings.

Here, in the MFP, the above-described job status screen and job history screen may be displayed in the state of showing contents unique to job-specific information. For example, the MFP, when displaying information on a FAX job, displays the job status screen and the job history screen that are adapted only for displaying the information on a FAX job. However, in the case where the MFP transmits image data to a plurality of transmission destinations using a different plurality of transmission methods (protocol), the MFP needs to display a job status screen or a job history screen that corresponds to the plurality of transmission methods. In this case, the screen to be displayed can show items common to the transmission methods set with respect to the plurality of transmission destinations, but it is difficult to display items that are unique to a given transmission method, and thus displayable information is restricted.

Therefore, in the present embodiment, in the case where a transmission job in which a plurality of transmission destinations are set is executed, display contents of the job status screen and the job history screen are controlled in accordance with the transmission methods set with respect to the respective transmission destinations. With this, by performing display control that is adopted for the set transmission methods, the user's convenience is further improved.

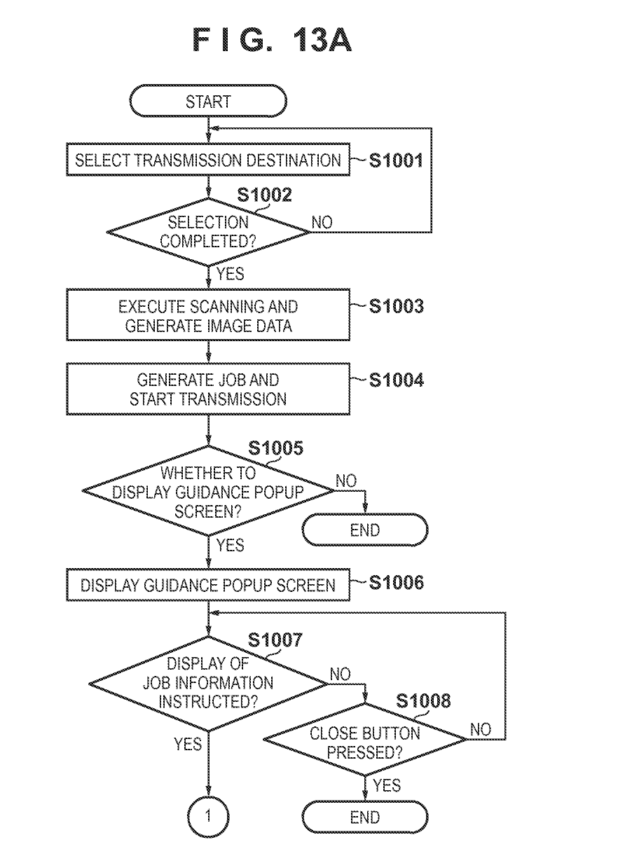

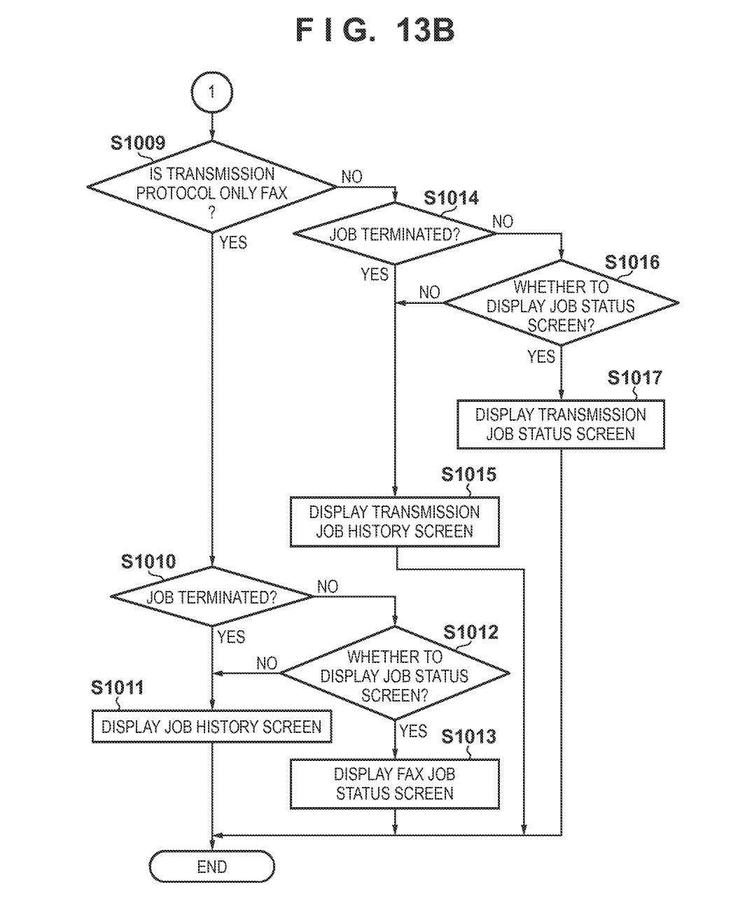

The following will describe display control, according to the second embodiment, of information on a transmission job that is executed by the MFP 100 when the transmission job is instructed to be executed, with reference to FIGS. 13A and 13B. Hereinafter, description on processing that is performed when an instruction to execute a transmission job using both the FAX function and the SEND function is made via the transmission execution screen 610 will be made. Note that the procedures of steps shown in FIGS. 13A and 13B are realized on the MFP 100 by the CPU 200 reading out the control program stored in the ROM 201 onto the RAM 202 and executing the control program. Also, display control of the operation unit 203 is executed by the UI control unit 301.

First, steps S1001 through S1008 are essentially similar to those in the first embodiment. However, in the present embodiment, in step S1001, a user selects a plurality of transmission destinations for transmission using the FAX function and the SEND function. That is, the CPU 200 receives, as settings of a transmission job, a plurality of transmission destinations and transmission methods (FAX and transmission protocols other than FAX) for transmitting image data to the respective transmission destinations, and starts, in step S1004, executing the transmission job in accordance with the received settings. The CPU 200 sequentially transmits the image data to the plurality of transmission destinations using the set respective transmission methods.

In the case where the procedure advances from step S1007 to step S1009, the CPU 200 (job management unit 305) determines based on the job management table 490 whether or not only FAX is set as transmission methods for transmitting the image data to the plurality of transmission destinations. If it is determined that only FAX is set as transmission methods (“Yes” in step S1009), the CPU 200 displays a screen that corresponds only to FAX, as the job status screen or the job history screen, on the operation unit 203. That is to say, the CPU 200 displays the job status screen or the job history screen that includes items unique to FAX on the operation unit 203. On the other hand, if it is determined that a transmission method (protocol) other than FAX as transmission methods is set with respect to at least one transmission destination (“No” in step S1009), the CPU 200 displays a screen including items common to the set plurality of transmission methods on the operation unit 203. That is to say, the CPU 200 displays, on the operation unit 203, the job status screen or the job history screen that includes items common to all the set transmission methods.

The processing from step S1010 through step S1013 are similar to the processing from step S909 through step S912 except that, in step S1011 or S1013, the job status screen or the job history screen that includes items unique to FAX is displayed on the operation unit 203. Also, the processing from step S1014 through step S1417 are similar to the processing from step S909 through step S912 except that, in step S1015 or S1017, the job status screen or the job history screen that includes items common to the set plurality of transmission methods is displayed on the operation unit 203.

As described above, in the present embodiment, in the case of execution of a transmission job in which a plurality of transmission destinations are set, display contents of the job status screen and the job history screen are controlled in accordance with the transmission methods set with respect to the respective transmission destinations. Therefore, by performing display control adapted for the set transmission methods, it is possible to further improve the user's convenience.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-275103, filed Dec. 17, 2012, which is hereby incorporated by reference herein in its entirety.

What is claimed is:

1. An image processing apparatus capable of communicating with an external apparatus via a network, the image processing apparatus comprising:
a reception unit configured to receive, after execution of a transmission job for transmitting image data to the external apparatus has started, a display instruction to display information on the transmission job;
a detection unit configured to detect an execution status of the transmission job upon receipt of the display instruction by the reception unit; and
a display control unit configured to display, on a display unit of the image processing apparatus, a job status screen that shows an execution status of a job that is currently being executed in the image processing apparatus, or a job history screen that shows an execution history of a job whose execution in the image processing apparatus is terminated, in accordance with the execution status detected by the detection unit.

2. The image processing apparatus according to claim 1,
wherein the display control unit is configured to display the job history screen on the display unit in a case where it is detected, as the execution status, that the execution of the transmission job has already been terminated, and to display the job status screen on the display unit in a case where it is detected, as the execution status, that the execution of the transmission job has not been terminated.

3. The image processing apparatus according to claim 1,
wherein the display control unit is configured to display the job history screen on the display unit in a case where it is detected, as the execution status, that the execution of the transmission job has already been terminated, and to display either the job history screen or the job status screen on the display unit in accordance with a previously set content in a case where it is detected, as the execution status, that the execution of the transmission job has not been terminated.

4. The image processing apparatus according to claim 1,
wherein the detection unit is configured to detect, as the execution status, after the start of the transmission job, whether the execution of the transmission job is already terminated, whether the transmission job is currently being executed, or whether the transmission job is in a standby state before the start of the execution.

5. The image processing apparatus according to claim 1, further comprising:
a setting unit configured to set whether or not to display a screen that is capable of receiving the display instruction.

6. The image processing apparatus according to claim 1, further comprising:
a starting unit configured to receive, as settings of the transmission job, a plurality of transmission destinations and transmission methods for transmitting image data to the respective transmission destinations, and to start executing the transmission job in accordance with the received settings,
wherein the display control unit is configured, when only facsimile transmission is set as the transmission method of the transmission job with respect to the plurality of transmission destinations, to display a screen that corresponds only to the facsimile transmission, as the job status screen or the job history screen, on the display unit.

7. The image processing apparatus according to claim 6,
wherein the display control unit is configured, when a transmission method other than the facsimile transmission is set as the transmission method of the transmission job with respect to at least one transmission destination, to display a screen that includes items common to the transmission methods set with respect to the plurality of transmission destinations, as the job status screen or the job history screen, on the display unit.

8. The image processing apparatus according to claim 1, further comprising:
a reading unit configured to read an image of an original to generate image data,
wherein the transmission job is a job for transmitting the image data generated by the reading unit to the external apparatus.

9. A method for controlling an image processing apparatus capable of communicating with an external apparatus via a network, the method comprising steps of:
receiving, after execution of a transmission job for transmitting image data to the external apparatus has started, a display instruction to display information on the transmission job;
detecting an execution status of the transmission job upon receipt of the display instruction in the receiving step; and
displaying, on a display unit of the image processing apparatus, a job status screen that shows an execution status of a job that is currently being executed in the image processing apparatus, or a job history screen that shows an execution history of a job whose execution in the image processing apparatus is terminated, in accordance with the execution status detected in the detecting step.

10. A computer-readable storage medium storing a computer program for causing a computer to execute steps of a method for controlling an image processing apparatus capable of communicating with an external apparatus via a network, the method comprising steps of:
receiving, after execution of a transmission job for transmitting image data to the external apparatus has started, a display instruction to display information on the transmission job;
detecting an execution status of the transmission job upon receipt of the display instruction in the receiving step; and
displaying, on a display unit of the image processing apparatus, a job status screen that shows an execution status of a job that is currently being executed in the image processing apparatus, or a job history screen that shows an execution history of a job whose execution in the image processing apparatus is terminated, in accordance with the execution status detected in the detecting step.
